(19) United States
(12) Patent Application Publication
(10) Pub. No.: US 2012/0120894 A1
(43) Pub. Date: May 17, 2012

(54) Apparatus and Method for Selecting a User From a Group of Users Sharing a Channel

(76) Inventor: Hans HOHNE, Helsinki (FI)

(21) Appl. No.: 13/322,330

(22) PCT Filed: May 28, 2009
(86) PCT No.: PCT/EP09/56541

§ 371 Date: Jan. 18, 2012

(51) Int. Cl. H04W 72/04

(52) U.S. Cl. 370/329

(57) ABSTRACT

An apparatus and a method for protecting persistent MAP allocation may be described. The protecting mechanism may use HARQ information or UL data as an implicit MAP ACK.

### TECHNICAL FIELD OF THE INVENTION

The present invention relates to a Base Station Apparatus, to a method for selecting a user, to a computer-readable medium for selecting a user, to a testing Mobile Station Apparatus, to a use of a HARQ DL ACK signal, to a use of a HARQ NACK signal for determining a MAP ACK, and to the use of a HARQ UL data for detecting a MAP ACK.

### BACKGROUND OF THE INVENTION

WiMAX systems (Worldwide interoperability for Microwave Access) can use the IEEE 802.16 or IEEE 802.16e standard for defining the communication protocol between a Base Station Apparatus (BS) and Mobile Station Apparatus (MS).

From the document IEEE (Institute of Electrical and Electronics Engineers) 802.16, “Draft Standard for Local and metropolitan area networks, Part 16: Air Interface for Broadband Wireless Access Systems”, Rev 2/D7, October 2008, a standard may be known, specifying an air interface, including a medium access control layer (MAC) and a physical layer (PHY), of combined fixed and mobile point-to-multipoint broadband wireless access (BWA) systems providing multiple services.

The scheme of persistent resource allocation can be used to support Voice over IP (VoIP) and other periodic traffic in a communication network. For applications like VoIP, the packet arrival rate can be predicted and the BS thus, may reduce the MAP overhead by transmitting an initial assignment message, which may be valid in a periodic sequence of future frames. MAP may be a name of a control message used in WiMAX™.

In a standard communication according to IEEE 802.16e standard the allocation of certain slots in a frame may be used for downlink (DL) communication (from BS to MS) and uplink (UL) communication (from MS to BS). The allocation of certain position in a frame, a slot or a subchannel may be defined by the BS (Base Station) for every single frame, sent from the BS to the MS (Mobile Station). Furthermore, the BS may inform the MS about the position of a frame or the subchannel, at which position the BS may expect receiving information from the MS. However, when periodic traffic may be detected, the structure of the following frames or succeeding frames may be defined by single MAP information. This MAP information may be valid for a predefined number of succeeding frames.

Thus, for these succeeding frames the MAP information may not have to be provided for every individual frame and therefore, the MAP information or the persistent allocation information substantially may have to be provided with the rate according to an Allocation Period (AP). In other words, for future transmission within a predefined time period, no additional MAP information may have to be provided from the BS since the MAP information sent in an initial frame may still be valid for the succeeding frames. This type of scheduling can be referred to as persistent scheduling and may allow reducing the MAP overhead in mobile WiMAX™ release 1.5.

There may be a need to provide a high reliability for persistent resource allocation information.

### SUMMARY OF THE INVENTION

According to an exemplary embodiment of the present invention, a Base Station Apparatus, a method for selecting a user, a computer-readable medium for selecting a user, a testing Mobile Station Apparatus, a use for a HARQ DL ACK signal, a use of a HARQ NACK signal and the use of a HARQ UL data transmission may be provided.

According to another exemplary embodiment of the present invention, a Base Station Apparatus may be provided which Base Station Apparatus or BS may comprise a Sending Device, Receiving Device and an Error Detecting Device.

In an example the Sending Device may be adapted for sending in a first channel, channel allocation information to a user, to an MS or to a destination. The channel allocation information may be associated with a data communication in a second channel or in a second subframe. In an example, the Receiving Device may be adapted for receiving in a third channel transmission status information for the data communication with the user.

In an example, the Error Detecting Device may be adapted to interpret missing transmission status information in the third channel as a corrupted or defective sending of the channel allocation information to the corresponding user in the first channel. The Error Detecting Device may further be adapted to provide the corresponding user to which sending the channel allocation information may have been failed.

Thus, a user having receipt defective channel allocation may be identified and the channel allocation information may be retransmitted.

According to another exemplary embodiment of the present invention, a method for selecting a user may be provided. The method may provide sending in a first channel a channel allocation information to a user, wherein the channel allocation information may be associated with a data communication or a data communication relationship in a second channel.

The method may further comprise receiving in a third channel transmission status information for the data communication with the user. In an example, the method can comprise interpreting a missing transmission status information in the third channel as corrupted sending of the channel allocation information to the corresponding user and the method may provide the corresponding user.

According to another exemplary embodiment of the present invention, a computer-readable medium may be provided, which computer-readable medium may comprise a program code, which when being executed on a processor may be adapted to carry out the method for selecting a user.

According to another exemplary embodiment of the present invention a program element may be provided, which, when being executed by a processor, may be adapted to carry out the method for selecting a user.

According to another exemplary embodiment of the present invention, a testing Mobile Station Apparatus may be provided. The testing Mobile Station Apparatus may be a MS which may allow testing whether a Base Station Apparatus may use the method for selecting a user.

The testing Mobile Station may comprise a Receiving Device and a Suppression Device. The Receiving Device may be adapted for detecting a channel allocation information and may control the Suppression Device such, that the Suppression Device suppresses transmitting a transmission status information. Therefore, the Suppression Device may be adapted to suppress transmitting a transmission status information such as a HARQ UL data, a HARQ DL ACK signal and a HARQ DL NACK signal.

According to a further exemplary embodiment of the present invention a computer-readable medium for testing a Base Station Apparatus may be provided, which may comprise program code, which when being executed on a processor may be adapted to carry out a method for testing a Base Station Apparatus.

According to a further exemplary embodiment a program element may be provided, which when being executed on a processor may carry out a method for testing a Base Station Apparatus.

A computer-readable medium may be a floppy disk, a hard disk, an USB (Universal Serial Bus) storage device, a RAM (Random Access Memory), a ROM (read only memory) or an EPROM (Erasable Programmable Read Only Memory). A computer readable medium may also be a data communication network, e.g. the Internet, which may allow downloading a program code.

According to an exemplary embodiment of the present invention the method for selecting a user may be a procedure for protecting a persistent MAP allocation IE.

In order to allocate resources persistently between a BS and MS, the BS may transmit a persistent resource allocation signal or a persistent resource allocation information element (IE), for example a persistent MAP allocation IE, a persistent HARQ (Hybrid Automatic Repeat Request) DL (Downlink) MAP IE (information element) for DL allocations and/or a persistent HARQ UL (uplink) MAP IE for UL allocations.

Since after a persistent resource allocation may have been transmitted, in a certain number of succeeding frames the MAP information may substantially not have to be provided, resources may be saved. The persistent HARQ DL/UL MAP allocation IE can be a critical IE in persistent scheduling mechanism. In other words, a loss of a single persistent HARQ DL/UL MAP IE (persistent HARQ DL MAP IE and/or persistent HARQ UL MAP IE) may mean that the MAP for the succeeding frames may not be available. Therefore, a plurality of measurements or means may be provided for providing secure error detection. The loss or corrupting of persistent MAP IE may not only affect a single frame, but it may affect the succeeding frames the number of which may be determined by the allocation period (ap).

As an example it can be specified that a MAP NACK (Not Acknowledge) channel may be established between an MS and a BS as a shared channel. This shared channel may be used by a plurality of MSs in order to indicate that a MAP decoding error may have occurred. The BS may assign the same MAP NACK channel index to one or more MSs such, that more than one MS may be able to transmit feedback information using a particular MAP NACK channel at the same time. In other words, the shared channel may allow indicating to a BS that at least one MS may have detected a decoding error when decoding the persistent MAP allocation IE. However, since a shared channel may be used for a group of MSs, the individual MS, which may have detected the decoding error, may not be detected.

Therefore, in another example for protecting the MAP message, a dedicated ACK (Acknowledge) channel may be assigned to every individual user. In contrast to the NACK channel the ACK channel may provide information when the corresponding persistent MAP allocation IE may have been correctly decoded. The MS which may have correctly decoded the persistent HARQ DL MAP IE or the persistent HARQ UL MAP IE may transmit a MAP ACK indication to the BS using the assigned dedicated MAP ACK channel, upon receipt of the corresponding persistent HARQ DL/UL MAP IE. The persistent HARQ DL MAP IE or the persistent HARQ UL MAP IE may include the Reduced Connection Identifier (RCID) of the corresponding MS.

The MAP share NACK channel and/or the MAP ACK channel may both be used for protecting the persistent MAP allocation IE. In other words, the MAP share NACK channel and/or MAP ACK channel may allow indicating to the BS if the persistent MAP allocation IE or persistent HARQ DL/UL MAP IE may have been corrupted or defective. However, the MAP ACK channel may use one slot of a frame per user within the fast feedback region of a frame and the MAP NACK channel may also use one slot per user within the fast feedback region. In WiMAX™ systems a slot may be the minimum transmission unit within an OFDMA (Orthogonal Frequency-Division Multiple Access) frame. The dedicated MAP ACK channel may have to be assigned for each individual user. Therefore, a single MAP ACK channel may have to be established between every MS and the BS for which MS a sub-burst may exist within a frame. If in an example there may exist a hundred of VoIP users in the network, which could be a common case in a commercial system or network, a large overhead may be generated only by providing a dedicated MAP ACK channel for each individual user.

The dedicated MAP ACK channel per user and the MAP share NACK channel per user group may optionally be used for protecting the persistent MAP allocation IE. In other words, either the dedicated MAP ACK channel and the MAP shared NACK channel or the share MAP NACK channel may be used individually or in combination for protecting transmitting of persistent MAP information. In other words the shared MAP NACK channel may be used without the dedicated MAP ACK channel and vice versa. The allocation of a share MAP NACK channel or MAP ACK channel may be explicitly indicated by the BS in a broadcast. Therefore, the user may be aware of whether only shared NACK channel may be used or both may be used.

A user group may be a collection or selection of users which may share the shared NACK channel. An example for determining users which may share a shared NACK channel may be users which are in the same persistent region. The persistent region may be a region in a frame which may be used for exchanging persistent information such as a persistent resource allocation IE or persistent MAP allocation IE.

The overhead or the use of channels in the fast feedback region may have to be reduced since the fast feedback region may be also used for other feedback mechanisms and if the fast feedback region may be used too much, the performance of giving feedback may be reduced. A dedicated MAP ACK channel per user in the fast feedback region may generate a large overhead in the fast feedback region.

In an example, the overhead used for fast feedback may limit the capacity of an uplink. This limitation may exist because the fast feedback region may also occupy a region of the uplink data frame. Therefore, the size of fast feedback region may be limited because of the finite capacity. Generally, if the number of users may be increased too much a huge amount of fast feedback channels may be required. Since these increased fast feedback channels may also occupy the region in the uplink, there may be less space left for uplink data within the frame.

However, a procedure for protecting the persistent MAP allocation IE may implement a cooperation of the shared MAP NACK channel and the HARQ mechanism. The HARQ mechanism may be used for protecting a data transmission between the BS and the MS in any direction.

The cost of dedicated MAP ACK channel may be high since every dedicated MAP ACK channel may occupy one slot for each sub-burst or for each user. By using the HARQ mechanism for MAP Ack (Acknowledge) assigning a dedicated MAP ACK channel for every sub-burst in the BS may be prevented.

In the BS or in the Base Station Apparatus the Receiving Device may substantially only assign one single shared NACK channel for a group of MSs within the same persistent region.

When the BS may detect the MAP NACK in the shared NACK channel, the BS may know that at least one of the connected users or MSs in the group may have not received or may have not been able to decode the persistent MAP allocation IE.

Therefore, the shared NACK channel may be used as an indication that an error may have occurred when at least one MS may have tried to decode the persistent MAP allocation IE.

The additional channel, for example the second and/or third channel may allow the BS to identify the individual MS which may have detected the error or the corrupted transmission.

Therefore, the Sending Device within the Base Station Apparatus may also be adapted to establish a shared NACK channel with a group of MSs. A group may comprise 16 users.

According to another exemplary embodiment of the present invention, the first channel and the second channel may be the same channels. In other words, the channel allocation information and the data that may be communicated between the MS and the BS, or between the user and the BS may be transported within or via the same channel.

In another example, the second channel and the third channel may be the same.

A channel may be a virtual channel. Thus, a channel may be defined by a position within an OFDM (Orthogonal Frequency Division Multiplex) frame of an OFDM message or within a OFDMA frame, by a position in a TDD (Time Division Duplex) frame and/or by a position within a FDD (Frequency Division Duplex) frame. In other words, in the same frame may a plurality of positions, sub-channels or sub-bursts exist which may be used for different purposes. For example, in a DL (downlink) frame in a certain position of the frame the persistent MAP allocation IE can be transported and in the same frame, in another sub-burst or another channel the data or DL data may be transported. Physically, however, the persistent MAP allocation IE and/or the DL data may be transported on the same physical channel or the same physical frequency or the same physical time slot or a mixture of them.

Furthermore, when the second channel and the third channel may be the same channels the user data, UL data or the data which may be sent from the MS to the BS may be used as an indication for a successful detection of persistent MAP allocation IE.

Substantially only if the MS may have received the persistent MAP allocation IE and the MS may have been able to detect the information correctly, the MS may be able to transmit the UL data correctly. The correct transmission of data may be specified in the IEEE 802.16 standard.

In another example, substantially only if the MS may have detected the persistent MAP allocation IE correctly, the MS may be able to send the HARQ DL ACK message and/or the HARQ NACK message in order to confirm or not confirm the data receipt from the BS to the MS. The existence of at least one of those signals may be interpreted as an MAP ACK. The handling of persistent MAP allocation IEs may be specified by the IEEE 802.16 standard. The standard may specify that substantially only when the MAP may have been successfully decoded, the MS may send data in the corresponding frames.

According to another exemplary embodiment of the present invention, the first channel, the second channel and the third channel may be at least one channel selected from the group of channels consisting of a slot in a downlink frame, a slot in an uplink frame, a slot in an OFDM (Orthogonal Frequency Division Multiplex) downlink frame, a slot in an OFDM uplink frame, a HARQ (Hybrid Automatic Response Request) channel, a fast feedback channel, a sub-frame of a Downlink frame (DL frame), a sub-frame of an Uplink frame (UL frame) and a channel according to the IEEE 802.16e standard.

Thus, a plurality of types of channels may be used for protecting a persistent MAP allocation IE without having separately to provide a dedicated MAP ACK channel.

According to yet another exemplary embodiment of the present invention, the Error Detecting Device may be further adapted to interpret at least one of receiving a HARQ UL data, a HARQ DL ACK signal and a HARQ DL NACK signal as an acknowledgement for receiving the channel allocation information at the user or as an implicit MAP ACK.

The sending of HARQ UL data may require a correct interpretation of the persistent MAP allocation IE in the first channel. In particular sending of the HARQ UL data may require the correct interpretation of the persistent HARQ UL MAP IE, for knowing the a correct position in a frame at which position the BS may expect the HARQ UL data. The MS may have received this knowledge about the correct position in the persistent MAP allocation IE. With this knowledge, the MS may be able to place the HARQ UL data or the payload data at the correct position in an UL frame.

Similar the HARQ DL ACK signal and the HARQ DL NACK signal may belong to a HARQ process for confirming the receipt of DL data within the MS. Thus, receiving the HARQ DL ACK signal and/or a HARQ DL NACK signal may indicate that the persistent MAP IE within the MS may have been correctly decoded.

According to yet another exemplary embodiment of the present invention, the Error Detecting Device may be further adapted to detect a non-acknowledge (NACK) signal in a shared NACK channel.

Detecting the non-acknowledge signal or NACK signal in a shared NACK channel may indicate that at least one of the MSs sharing the NACK channel may not have correctly decoded a persistent MAP allocation IE.

According to another exemplary embodiment of the present invention, the Error Detecting Device may be further adapted to retransmit the channel allocation information to all users or to all MSs sharing a NACK channel in the case that the trans-mission status information may be available.

If the BS may not find any indication of failure from missing HARQ ACK or missing data, the BS may choose retransmitting allocation information for all users assigned to the shared NACK channel. The retransmission may be necessary due to the share MAP NACK being detected by the BS, i.e. the MAP NACK in the shared NACK channel may be detected.

In an example, the protection of the share MAP NACK may be stronger than protection of the HARQ ACK. Therefore, it may be possible that the BS may misunderstand a noise as a HARQ ACK and therefore, the BS may not be able to find any failure indication. A retransmission scenario thus may increase the reliability.

In other words, if the BS may not find any indication of failure from missing HARQ ACK or missing data, the BS may choose to retransmit allocation information for all users assigned to the shared NACK channel.

Or still in other words, in a case when the BS may detect a shared MAP NACK and if at the same time a HARQ ACK may be detected or a UL data may be detected, a retransmission may be started for reliability reasons.

Thus, for example if the Detecting Device may receive in a shared NACK channel an indication that at least one user from the group of users may not have been able to decode the persistent MAP allocation IE, however, if the BS may not find an indication of a missing HARQ ACK or a missing UL data, the BS may choose to retransmit the allocation information for all users assigned or subscribed to the shared NACK channel. Since the HARQ feedback channel may only use half a slot it may be possible with a certain probability that a false alarm may be generated. A false alarm may be generated if HARQ ACK may be available or data may be available, however, the BS may have detected a MAP NACK in the shared channel. In such a case, the BS may retransmit allocation information for substantially all users assigned to the shared NACK channel.

According to another exemplary embodiment of the present invention, a channel allocation information may be at least one information selected from the group of information consisting of a persistent MAP allocation IE, a persistent HARQ DL MAP IE and a persistent HARQ UL MAP IE.

According to another exemplary embodiment of the present invention, the user may be at least one apparatus selected from the group of apparatuses consisting of a Mobile Station, a Mobile Station according to IEEE 802.16e, a cell phone, a personal digital assistant and a notebook.

It has also to be noted that exemplary embodiments of the present invention and aspects of the invention have been described with reference to different subject-matters. In particular, some embodiments have been described with reference to apparatus type claims whereas other embodiments have been described with reference to method type claims. However, a person skilled in the art will gather from the above and the following description that unless other notified in addition to any combination between features belonging to one type of subject-matter also any combination between features relating to different subject-matters in particular between features of apparatus type claims and the features of method type claims may be considered to be disclosed within this application.

These and other aspects of the present invention will become apparent from and elucidated with reference to the embodiments described hereinafter.

Exemplary embodiments of the present invention will be described in the following with reference to the following drawings.

### BRIEF DESCRIPTION OF THE DRAWINGS

FIG. 1 shows a block diagram of a Base Station Apparatus according to an exemplary embodiment of the present invention.

FIG. 2 shows a high level diagram for the channel structure for protecting a persistent DL MAP allocation IE according to an exemplary embodiment of the present invention.

FIG. 3 shows a high level diagram for the channel structure for protecting a persistent UL MAP allocation IE according to an exemplary embodiment of the present invention.

FIG. 4 shows a statistical diagram showing the reduction of number of channels when using a protection mechanism according to an exemplary embodiment of the present invention.

FIG. 5 shows a block diagram of a testing Mobile Station Apparatus according to an exemplary embodiment of the present invention.

FIG. 6 shows a flow diagram for a method for selecting a user according to an exemplary embodiment of the present invention.

FIG. 7 shows a flow diagram for a method for testing a Base Station Apparatus according to an exemplary embodiment of the present invention.

### DETAILED DESCRIPTION

The illustration in the drawings is schematic. In different drawings, similar or identical elements are provided with the same reference numerals.

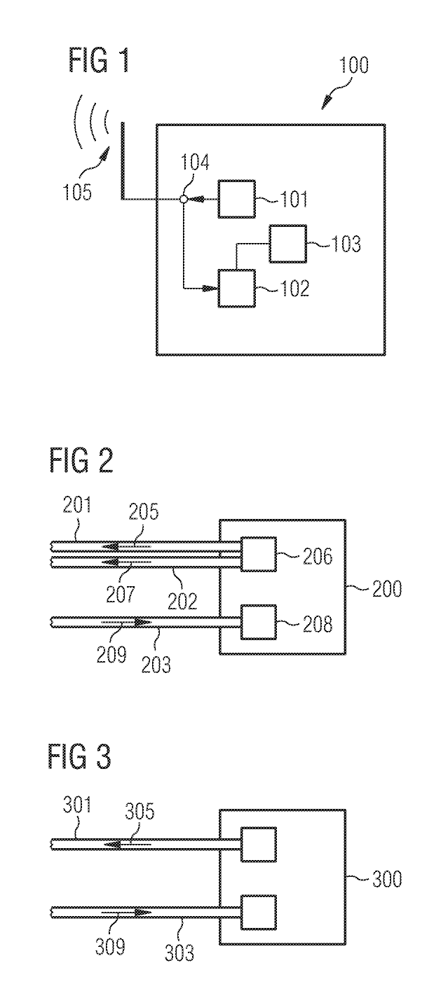

The block structure of the Base Station Apparatus 100 as depicted in FIG. 1 shows the Sending Device 101, the Receiving Device 102 and the Error Detecting Device 103, which is connected to the Receiving Device 102.

The Sending Device 101 and the Receiving Device 102 are connected to the Filter Device 104 or Switching Device 104, which allows the antenna 105 to be used in sending and receiving direction.

The Sending Device 101 is adapted to send channel allocation information such as persistent MAP allocation IE, persistent HARQ DL MAP IE or persistent HARQ UL MAP IE via the antenna 105 to an MS, which is not shown in FIG. 1. The channel allocation information allows the MS to send data at a predefined position, for example at a predefined channel within a frame, when sending information from the MS to the BS.

Since the BS 100 determines with the Sending Device 101 and by using the channel allocation information the position where the BS 100 expects the received information, the MS can provide data on that certain position. However, for providing information at the certain position the MS has to decode the MAP information for example the persistent MAP information, which comprises a link to the position to be used in the succeeding communication. Decoding the MAP information may require a non-corrupted data transmission.

Thus, the channel allocation information is associated with a data communication and thus, the BS 100 may influence the MS at which position the data communication happens. The data communication may uses the channel allocation information.

The Receiving Device 102 does not only receive the data from the MS. The Receiving Device 102 via antenna 105 also receives information in a third channel, which provides information about the status of the data transmission.

In an example, the MS can use the HARQ ACK signals or HARQ NACK signals to indicate to the BS 100 whether a data trans-mission from the BS 100 to the MS has been successful. If the data transmission has not been successful the HARQ ACK/NACK can indicate whether at least a part of the information has to be retransmitted. In both cases, i.e. in the case that the BS receives an acknowledgement information and/or a non-acknowledgement information, the Base Station 100 realizes that the MS has been successfully decoding the persistent MAP allocation IE. If the MS was not successful, the MS may not be able to send any information to the BS. Then, NACK and/or ACK are missing. The position or channel of the HARQ ACK or HARQ NACK within a frame may also depend on the persistent MAP information previously sent to the MS. Or in other words, the HARQ ACK or NACK may also be indicated by the MAP. The MAP information in an example may be a pointer to a position within a frame.

The BS 100 sets up with at least one of the MSs a shared NACK channel when the BS 100 starts operation. The Error Detecting Device 103 is monitoring this shared NACK channel. Thus, the BS knows that the at least one user or at least one of the users or of the MSs has not received the persistent MAP allocation IE. Then in a further step the BS 100 can select from the at least one user of the group of users sharing the shared NACK channel this particular user, who may not have receipt the persistent MAP allocation information.

Once the user who did not decode the persistent MAP allocation IE will be identified, the persistent MAP allocation IE can be retransmitted, in particular the IE can be retransmitted to that identified user. The retransmission of the persistent MAP allocation IE however may depend on the type of communication.

The types of communication are a DL communication and an UL communication. The DL communication is a communication from the BS to the MS and the UL communication is a communication from the MS to the BS.

In the case of a DL communication or downlink communication, i.e. if the BS wants to transmit data to the MS, a DL persistent allocation is conducted. In an example, the persistent MAP IE, i.e. the persistent HARQ DL MAP IE, may be sent together with the DL data, which DL data has to be sent from the BS to the MS. In other words, the MAP information, which allows the MS to identify what structure the BS expects from the MS to use when the MS communicates with the BS, will be sent in the same frame or the same channel as the DL data itself. If the BS 100 receives a corresponding HARQ DL ACK or if the BS receives a corresponding HARQ DL NACK for the data communication on the fast feedback channel, the BS 100 and in particular the Receiving Device 102 and the Error Detecting Device 103 can take the receipt of HARQ DL ACK or HARQ DL NACK as an indication that the MS has successfully decoded the persistent MAP IE. Thus, this may be an implicit MAP ACK.

The HARQ ACK/NACK mechanism may however be a mechanism which may be set up to identify whether the DL data has been trans-mitted from the BS to the MS without corruption. Thus a different or independent mechanism may be utilized in order to protect the persistent MAP allocation IE. Without having the MAP information the MS may not be able to send the HARQ DL ACK and/or HARQ DL NACK.

Thus, the HARQ DL ACK and/or the HARD DL NACK can be used as an implicit MAP ACK. In other words, if a HARQ DL ACK and/or a HARQ DL NACK information or corresponding signals are missing, the Error Detecting Device may realize that the corresponding MS may have not received the persistent MAP IE. Since the HARQ DL ACK/HARQ DL NACK mechanism is realized for each user or for each MS individually, a dedicated HARQ feedback channel exists. Therefore, by identifying the CID or RCID, the BS can identify and provide the corresponding user, which has received corrupted or defective persistent MAP allocation information or signals.

The HARQ DL ACK and/or HARQ DL NACK information may be trans-mitted via the HARQ fast feedback channel, which has a size of half a slot. The dedicated MAP ACK channel, which may be replaced by using the HARQ fast feedback channel, however, may have a size of one slot. The size of one slot may mean a higher reliability than the half slot. The false alarm probability can be optimized with a careful design in implementation. A false alarm may occur for the case that no ACK/NACK signalling, i.e. the absence of ACK/NACK, in the HARQ fast feedback channel is interpreted as an ACK or NACK signalling. Thus, the ACK and/or NACK signalling may be implemented such that the false alarm probability may be reduced. In other words, since the HARQ fast feedback channel sizes substantially only half a slot, a probability exists, that even if no ACK/NACK signalling is detected in the HARQ fast feedback channel by the Error Detecting Device, the Error Detecting Device despite detects an ACK/NACK signalling.

A missing ACK/NACK signalization may be detected when a timer expires.

For protecting an UL (uplink) data connection from the user to the BS 100 the receiving of HARQ UL data in the BS may be an indication of correct decoding of persistent HARQ UL MAP information. Thus, for the UL persistent allocation, if a BS 100 detects the HARQ UL data transmission in the corresponding frame or the corresponding channel with time which is relevant to the frame where the persistent MAP IE has been sent, the receipt of HARQ UL data could be regarded as an indication that the MS has successfully decoded the persistent MAP IE. In this way, the HARQ UL data can be used as an implicit MAP ACK.

In other words, the receipt of HARQ UL data could be regarded as an indication that the MS has successfully decoded the persistent MAP IE, if the BS detects the HARQ UL data trans-mission in the corresponding frame with time relevance to the frame where the persistent MAP IE has been sent. Generally there is a time relevance or association between the allocation transmission and data transmission. For example, in a frame N the resource allocation, e.g. a MAP information, is transmitted by the BS to the MS, then the MS should send the uplink data in frame N+T. Here the value T is the time relevance.

In other words, if a BS 100 expects data transmitted from the MS to the BS 100, the BS 100 sends the persistent HARQ UL MAP IE as channel allocation information to the MS. The MS uses the channel allocation information of such persistent HARQ UL MAP IE in order to transmit the corresponding UL data in the corresponding frame. The UL data is sent within the frame with an association to the frame in which the persistent UL MAP IE has been sent.

The HARQ UL data could be used as an implicit MAP ACK. For UL data reception or for HARQ UL data reception there may substantially be no false alarm problem or a reduced false alarm problem as it may exist in HARQ ACK/NACK. Therefore, the detection of receiving uplink data may be more reliable than detecting the HARQ ACK/NACK in the fast feedback channel.

If a BS or Base Station Apparatus 100 does not find any indication of failure from missing HARQ ACK or missing data, the BS may choose to retransmit allocation information for all users assigned to the shared NACK channel. This means that, first, the BS has received a share MAP NACK indicating the failure; second, the BS cannot identify the individual user from HARQ ACK/NACK or UL data. This may be caused by some false alarm problem. So the BS has to retransmit all the allocation information for all users contained in the share MAP NACK message or for all those users contained in the group of users sharing the NACK channel.

The BS 100 may avoid using of a dedicated MAP ACK channel for each user, when using another channel or another signal, which is different from an MAP signal or a MAP channel, for example, when using the HARQ UL data or the HARQ ACK/HARQ NACK. Therefore, a large occupancy in the fast feedback region may be prevented if dedicated ACK channels are prevented.

With resource shifting support, the persistent allocated shared NACK channel has to be supported for all users. The shared NACK channel has to be supported for all users because while transmitting de-allocation MAP message, the BS could not assign the dedicated ACK channel for all users as determined by the format of the resource shifting. However, for implementing resource shifting, the BS 100 needs the feedback of all the influenced users. Therefore, for resource shifting, the MAP share NACK channel has to be assigned at the beginning of persistent allocation. Then, since the MAP shared NACK channel is necessary and the fact that the shared NACK channel occupies substantially only one slot in the fast feedback region and is persistently allocated all through the traffic time, the concept of shared NACK channel and/or using the HARQ transmission and/or the HARQ feedback status shows how resources can be saved.

In other words, resource shifting is a method used in persistent scheduling technology of WiMAX™. In resource shifting, the dedicated MAP ACK channel may not be explicitly allocated to each user because of the particular specified resource shifting format. Therefore, in such a resource shifting case, substantially only the share MAP NACK channel can be used because the share MAP NACK channel is allocated at the beginning of the persistent scheduling allocation and maintained valid all through the persistent scheduling period.

It may be an aspect of the invention to group users and make the grouped users share one NACK channel and using the HARQ transmission and/or feedback status as a complementary or as an add-on to the HARQ transmission or as an add-on to the shared NACK channel. In other words, the usage of the HARQ transmission and/or feedback status for persistent scheduling MAP ACK/NACK is proposed.

In other words, instead of allocating dedicated MAP ACK channel for every user, which may also not allow resource shifting, the MAP shared NACK channel may have to be established in order to allow informing all users about resource shifting. This established shared NACK may be used for protecting the persistent MAP allocation IE. The MAP shared NACK channel is persistently allocated substantially all through the traffic living time. Thus, using the single shared NACK channel for grouped users and using the HARQ transmission (UL data) or the HARQ feedback status (HARQ UL ACK/NACK) as a complementary may allow reducing the MAC (Medium Access Control) overhead for the persistent scheduling.

FIG. 2 shows an example for the persistent MAP allocation for a DL connection. As shown in FIG. 2, the BS 200 has established two channels. A first channel 201 and a second channel 202. The first channel 201 and the second channel 202 can be the same channel. For example, the first channel 201 and the second channel 202 may be transmitted within the same DL frame from the BS 200 to the MS 204. Furthermore between MS and BS the third channel 203 is established.

If the BS 200 wants to transmit data to the MS 204, for example voice over IP traffic data, the BS sends via the first channel 201 allocation information 205, for example persistent HARQ DL MAP IE. In the second channel 202 the Sending Device 206 of the Base Station 200 sends the DL data 207 from the BS to the MS. The channel allocation information or the persistent HARQ DL MAP IE is associated with the DL data 207, transmitted in the second channel 202 in order to allow the MS to find the DL data position in a corresponding frame.

The frame may comprise the first channel 201 and the second channel 207. In order to either confirm the correct receipt of the DL data 207 or in the case of corruption in order to request for more information, on the third channel 203 HARQ DL ACK or HARQ DL NACK information is sent from the MS to the BS 100, 200. The Receiving Device 208 and/or the Error Detecting Device 208 of the BS 200 may realize the correct or incorrect transmission of the persistent IE 205.

FIG. 2 does not show the shared NACK channel, which links the BS 200 with the MS (not shown in FIG. 2) and a plurality of further MS. By interpreting the HARQ DL ACK 209 or the trans-mission status information 209, the BS 200 can find out that any of the group of MSs 204 had problems in identifying the persistent IE 205 and provide which individual MS had the problems.

FIG. 3 shows the channel structure in the case of UL persistent allocation. The BS 300 uses the first channel 301 to send channel allocation information 305 or a persistent UL MAP IE 305 from the BS 300 to the MS (not shown in FIG. 3). This persistent UL MAP IE 305 is associated with a third channel 303 or the UL data channel 303. Thus the UL data 309 can be used as an indication for successfully decoding of the persistent UL MAP IE 305. In this case the second channel and the third channel 303 are the same, i.e. the channel allocation information 305 for the persistent UL IE is association with the UL data communication 309 in the third or second channel 303.

Successfully receiving UL data, makes the Error Detecting Device 103 to assume that the persistent MAP IE 305 has been decoded within MS.

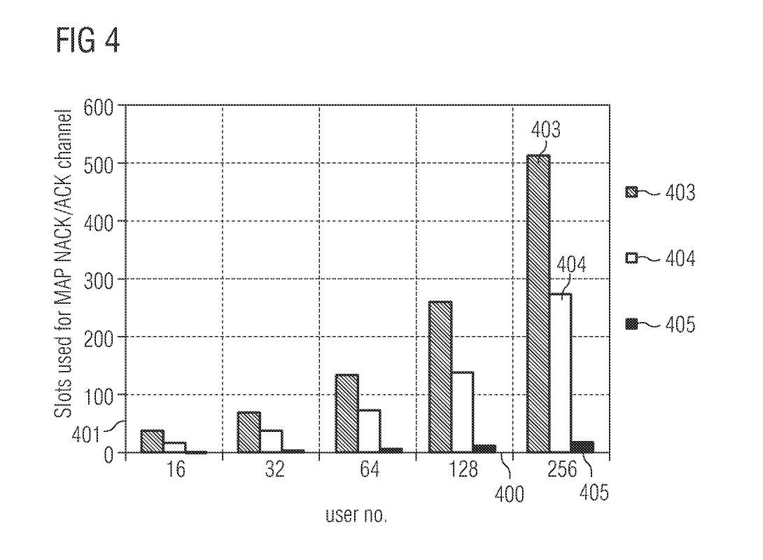

FIG. 4 shows a statistic diagram comparing the number of required slots used in fast feedback region for MAP NACK/ACK channels in a persistent scheduling. On the abscissa 400 the number of users is provided and on the ordinate 401 the slots used for MAP NACK/ACK channel is provided.

Using for every user a dedicated NACK channel and a dedicated ACK channel as shown with block 403 would result in a number of slots, wherein number of slots are calculated as users (Nuser) times 2 (slots=Nuser*2).

As shown in FIG. 4 this usage of dedicated channels 403 would lead to the most required numbers of slots.

In a second case 404 it is assumed that for 16 users a shared NACK channel is used and for every user a dedicated ACK channel is available. This results in a number of slots (slots=Nuser*(1+1/16)) which results in a medium number 404 of slots of fast feedback channels.

Using in a fast feedback region for the MAP NACK/ACK channel in persistent scheduling only one shared NACK channel for every 16 users and using either UL data or HARQ ACK/NACK would only mean a number of additional slots of slots=Nuser/16 405. FIG. 4 shows that only using an additional shared channel reduces the number of slots used in the fast feedback region for the MAP NACK/ACK channel in persistent scheduling.

The method for selecting a user may allow reducing signalization overhead induced by dedicated MAP ACK channel. For example, in the case of 16 users per group, the overhead can be reduced from N user*2 to N user/16 slots.

Using the method for selecting a user may prevent changing a standard. The implementation of the method for selecting a user may be identified by tracing signalization traffic, for example by employing a testing MS.

FIG. 5 shows the testing Mobile Station Apparatus 500, which can be used to proving the usage of the proposed method in a BS (not shown in FIG. 5).

The testing MS 500 comprises the Receiving Device 501 and the Suppression Device 503 and the sending Device 504. Furthermore the Receiving Device 501 and the Sending Device 502 are linked with the Suppression Device 503.

The Receiving Device 501 may be connected via an antenna to a BS and the Receiving Device 501 is adapted to detect a channel allocation information for example in a first channel. The Suppression Device 503 is adapted to suppress transmitting of a transmission status information, such as HARQ DL ACK, HARQ DL NACK or UL data to the BS (not shown in FIG. 5) under test.

The method, which may be investigated with the testing MS may be implemented in the BS. The MS and the BS may be connected via an air interface. The testing MS Apparatus 500 may stimulate the BS under test to show if the inventive method may be employed.

The BS under test may be configured to disable the dedicated MAP ACK channel. When receiving the persistent MAP allocation IE 205, 305 which contains the RCID of the MS 500, the Suppression Device 503 of the testing MS may be configured such that no MAP NACK is sent if the MAP shared NACK channel is assigned. With such a configured testing MS 500 some tests can be conducted on the BS.

For the DL persistent scheduling, when the MS 500 receives the DL HARQ data 207 in the same frame with the related persistent MAP allocation IE 205, the MS 500 may prevent sending any feedback in the HARQ fast feedback channel 203. The HARQ fast feedback channel may be connected to the Sending Device 502. The Sending device is connected to the Suppression Device 503. If the BS (not shown in FIG. 5) keeps on retransmitting the persistent MAP allocation IE 205 related to the testing MS 500, the BS may use the proposed method for selecting a user. The Receiving Device 501 is adapted to detect that the BS keeps on retransmitting persistent MAP allocation IE. The fact that the persistent MAP allocation IE is related to the testing MS 500 may be indicated by the RCID.

A BS which may not have implemented the method for selecting a user, may need the dedicated MAP ACK channel to identify the particular user for MAP retransmission. If only the share NACK channel is used, the BS has to retransmit to all the refated users and may not be able to keep on retransmitting a persistent MAP allocation IE related to the testing MS, which would have to be identified as a particular user. In other words, in order to keep on retransmitting the persistent MAP allocation IE related to a particular user, the particular user may have to be identified before by a dedicated MAP ACK channel or by the method for selecting a user. Since the BS is configured with a disabled dedicated MAP ACK channel, the BS may substantially only receive information about the particular user by using the method for selecting a user.

For the UL persistent scheduling when the uplink resource 303 has been granted in the UL persistent MAP allocation IE, i.e. when the MS 500 has detected and granted a data communication to the BS the MS 500 may prevent sending any data in the allocated resource 303, for example the UL data channel 303 associated with the channel allocation information 305. If the BS (not shown in FIG. 5) keeps on retransmitting the persistent MAP allocation IE 305 related to the MS 500, the BS may use the proposed method for selecting a user.

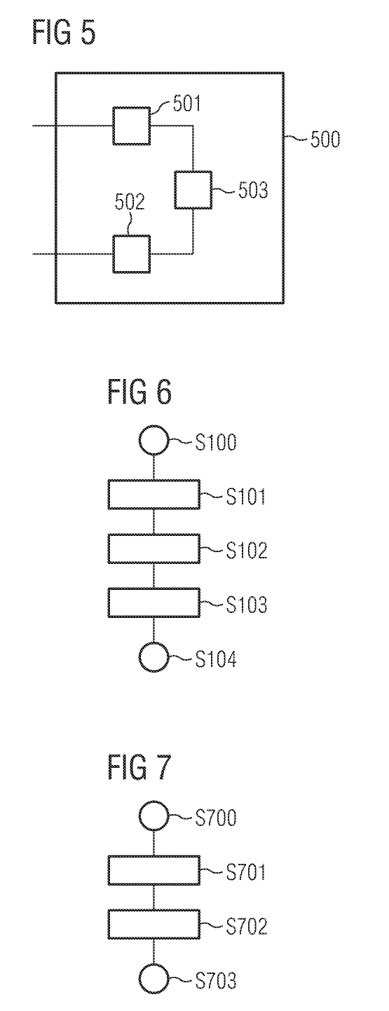

FIG. 6 shows a flow-chart of a method for selecting a user. The method starts in an idle state S100. In step S101 in the first channel 201, 301 a channel allocation information 205, 305 is sent to a user, wherein the channel allocation information 205, 305 is associated with the data communication in a second channel. In step S102 in a third channel 203, 303 a transmission status information 209, 309 for the data communication with the user is received.

In step S103 a missing transmission status information 209, 309 in the third channel 203, 303, e.g. missing HARQ DL ACK, HARQ DL NACK or HARQ UL data, is interpreted as a corrupted sending of the channel allocation information 205, 305 to the corresponding user. Furthermore, in step s103 the corresponding user is provided, for which the missing transmission status information 209, 309 has been detected.

In step S104 the method is in the idle state.

FIG. 7 shows a flow-chart for a method for testing a Base Station Apparatus.

The method starts in step S700, in an idle state. In step S701 a channel allocation information 205, 305 is detected within an MS and in step S702 the transmission of a transmission status information 209, 309 is suppressed. Then the idle state S703 is reached.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

### ACRONYMS AND TERMINOLOGY

VoIP Voice over IP (Internet Protocol)

### HARQ Hybrid Automatic Repeat Request

### DL Downlink

UL Uplink

1. Base Station Apparatus comprising:
a Sending Device;
a Receiving Device;
an Error Detecting Device;
wherein the Sending Device is adapted to send in a first channel a channel allocation information to a user;
wherein the channel allocation information is associated with a data communication in a second channel;
wherein the Receiving Device is adapted to receive in a third channel a transmission status information for the data communication with the user;
wherein the Error Detecting Device is adapted to interpret a missing transmission status information in the third channel as a corrupted sending of the channel allocation information to the corresponding user; and
wherein the Error Detecting Device is adapted to provide the corresponding user.

2. Base Station Apparatus of claim 1, wherein
the first channel and the second channel are the same channels; or
the second channel and the third channel are the same channels.

3. Base Station Apparatus of claim 1, wherein the first channel, the second channel and the third channel are at least one channel selected from the group of channels consisting of
a slot in a downlink frame;
a slot in an uplink frame;
a slot in an OFDM downlink frame;
a slot in an OFDM uplink frame; an HARQ channel;
a fast feedback channel;
a sub-frame of a downlink frame; a sub-frame of an uplink frame; and a channel according to IEEE 802.16e.

4. Base Station Apparatus of claim 1, wherein the Error Detecting Device (103) is further adapted to interpret at least one of receiving a HARQ UL data, a HARQ DL ACK signal and a HARQ DL NACK signal as an acknowledgement for receiving the channel allocation information at the user.

5. Base Station Apparatus of claim 1 the Error Detecting Device is further adapted to detect a non-acknowledge signal in a shared NACK channel.

6. Base station Apparatus of claim 1, wherein the Error Detecting Device is further adapted to retransmit the channel allocation information to all users sharing a NACK channel if the transmission status information is available.

7. Base Station Apparatus of claim 1, wherein the channel allocation information is at least one information selected from the group consisting of
a Persistent MAP allocation IE;
a Persistent HARQ DL MAP IE; and
a Persistent HARQ UL MAP IE.

8. Base Station Apparatus of claim 1, wherein the user is at least one apparatus selected from the group of apparatuses consisting of:
a Mobile Station;
a Mobile Station according to IEEE 802.16e;
a Mobile Station according to IEEE 802.16;
a cell phone;
a personal digital assistant; and a notebook.

9. Method for selecting a user, comprising:
sending in a first channel a channel allocation information to a user;
wherein the channel allocation information is associated with a data communication in a second channel;
receiving in a third channel a transmission status information for the data communication with the user;
interpreting a missing transmission status information in the third channel as a corrupted sending of the channel allocation information to the corresponding user; and
providing the corresponding user.

10. Computer readable medium for selecting a user, comprising a program code, which, when executed on a processor, is adapted to carry out:
sending in a first channel a channel allocation information to a user;
wherein the channel allocation information is associated with a data communication in a second channel;
receiving in a third channel a transmission status information for the data communication with the user;
interpreting a missing transmission status information in the third channel as a corrupted sending of the channel allocation information to the corresponding user; and
providing the corresponding user.

11. (canceled)

12. (canceled)

13. (canceled)
